(19) United States
(12) Patent Application Publication
(10) Pub. No.: US 2013/0107022 A1
(43) Pub. Date: May 2, 2013

(54) 3D USER INTERFACE FOR AUDIO VIDEO DISPLAY DEVICE SUCH AS TV

(71) Applicant: Peter Shintani, San Diego, CA (US)

(72) Inventor: Peter Shintani, San Diego, CA (US)

(73) Assignee: SONY CORPORATION

(21) Appl. No.: 13/281,610

(22) Filed: Oct. 26, 2011

(51) Int. Cl. H04N 13/04

(52) U.S. Cl. 348/51; 348/E13.026

(57) ABSTRACT

Three dimensional AVDD display technology can be used to display user interfaces or elements of user interfaces and can be used in cooperation with one or plural cameras to enable a viewer of the AVDD to “touch” a user interface or part of a user interface presented in three dimensional space.

### I. FIELD OF THE INVENTION

The present application relates generally to user interfaces (UI) for audio video display devices (AVDD) such as televisions (TVs).

### II. BACKGROUND OF THE INVENTION

User interfaces for AVDDs such as TVs have been provided in which a person can select elements on the UI to cause certain actions to be executed. For example, a user interface may be presented with volume and channel change selector elements that a person using a remote control (RC) can select using the point and click capability of the RC. Or, a touch screen may be provided and a person can touch the screen over the desired UI element to select it.

As understood herein, UN can be an important entertainment adjunct, both by minimizing the complexity of causing certain desired actions to be executed and also by providing an enjoyable experience to the person who is interacting with the UI.

### SUMMARY OF THE INVENTION

According to principles set forth further below, an audio video display device (AVDD) includes a processor, a video display, and computer readable storage medium bearing instructions executable by the processor. Using the instructions stored on the computer readable storage medium, the processor can present a three dimensional (3D) user interface (UI) on the video display in a foreground of an image of the display. At least a first element of the 3D UI may have a simulated element position that makes the first element appear to be closer to a viewer of the display than the image in a dimension that is perpendicular to the image presented on the display. The processor can also detect a person's appendage in proximity to the first element and may be responsive to a determination that the person's appendage is substantially co-located with the simulated element position. The response by the processor to co-location of the appendage with the first element may be to execute a first function associated with the first element.

The simulated element position can be distanced from the display in the dimension that is perpendicular to the image presented on the display. The 3D UI may include plural elements at least some of which appear to be closer to a viewer of the display than the image, in a dimension that is perpendicular to the image presented on the display. Alternatively, the 3D UI may include plural elements all of which appear to be closer to a viewer of the display than the image in a dimension that is perpendicular to the image presented on the display.

The AVDD can include at least one camera that images the viewer's appendage and communicates with the processor. It may include at least two cameras, or alternatively at least three cameras, that image the viewer's appendage and communicate with the processor. In all cases, the processor can determine a location of the appendage relative to the display using images from the number of cameras present (at least one, at least two, or at least three). The processor can determine that the viewer's appendage is moving toward the simulated element position and in response can animate the first element to make the first element move toward the viewer's appendage in the dimension that is perpendicular to the image presented on the display.

In another embodiment, an audio video display device (AVDD) can include a processor, a video display, and a computer readable storage medium. The storage medium may bear instructions executable by the processor to present on the display a 3D UI at least a portion of which appears to be in front of the display and distanced therefrom.

In another aspect, a method can include presenting an image on a 3D video display and presenting in simulated space in front of the image and distanced from a user interface (UI) that can include at least one element selectable by a viewer. The element may be selectable by the viewer locating an appendage at a corresponding location in front of the 3D video display and distanced from the front of the video display.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of a non-limiting example system in accordance with present principles;

FIG. 2 is a flow chart of example logic in accordance with present principles; and

FIG. 3 is a schematic diagram of the 3D UI.

### DETAILED DESCRIPTION OF THE PREFERRED EMBODIMENT

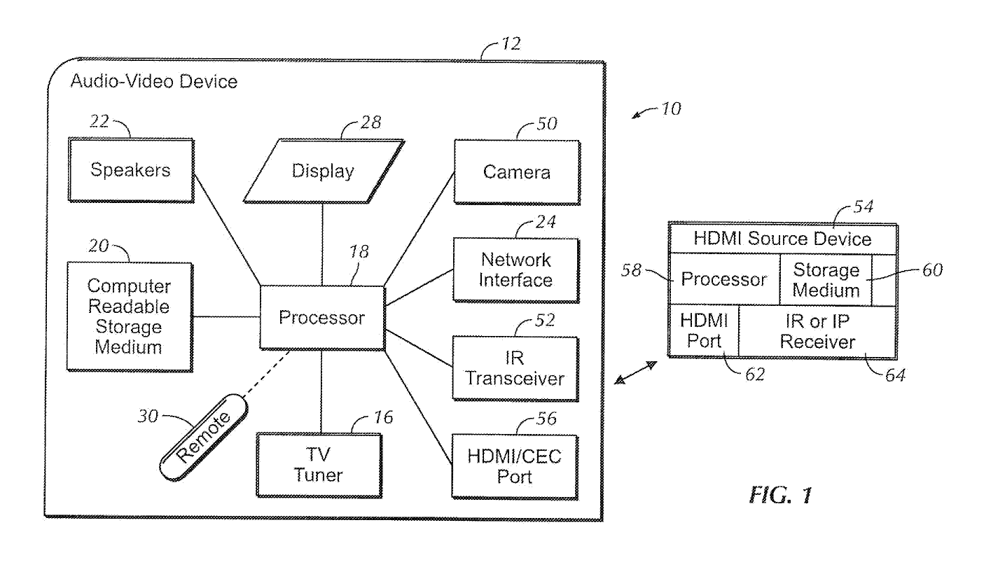

Referring initially to the non-limiting example embodiment shown in FIG. 1, a system 10 includes an audio video display device (AVDD) 12 such as a TV including a TV tuner 16 communicating with a TV processor 18 accessing a tangible computer readable storage medium 20 such as disk-based or solid state storage. The AVDD 12 can output audio on one or more speakers 22. The AVDD 12 can receive streaming video from the Internet using a built-in wired or wireless network interface 24 (such as a modem or router) communicating with the processor 12 which may execute a software-implemented browser.

Video is presented under control of the TV processor 18 on a TV display 28 such as but not limited to a high definition TV (HDTV) flat panel display, and preferably is a three dimensional (3D) TV display that presents simulated 3D images to a person wearing 3D glasses watching the TV or otherwise, e.g., using holograms or other 3D technology. For example, the display 28 may be an autostereoscopic display, or active shuttered 3D glasses that the viewer wears to view a sequential display 28 is also contemplated. If a 3D display is used, images or elements of a UI can be placed in the foreground, thereby eliminating the necessity of physically touching the surface of the display. Finger prints and smudges on the active area of the display 28 thus are greatly lessened. In other words, utilizing the z axis (the dimension which is perpendicular to the x-y plane defined by the display) allows for a more easily interpreted image presented on display 28 as UI elements are more readily distinguished.

User commands to the processor 18 may be wirelessly received from a remote control (RC) 30 using, e.g., rf or infrared as well as from the below-described 3D UI. Audio-video display devices other than a TV may be used, e.g., smart phones, game consoles, personal digital organizers, notebook computers and other types of computers, etc.

TV programming from one or more terrestrial TV broadcast sources as received by a terrestrial broadcast antenna which communicates with the AVDD 12 may be presented on the display 28 and speakers 22. The terrestrial broadcast programming may conform to digital ATSC standards and may carry within it a terrestrial broadcast EPG, although the terrestrial broadcast EPG may be received from alternate sources, e.g., the Internet via Ethernet, or cable communication link, or satellite communication link.

TV programming from a cable TV head end may also be received at the TV for presentation of TV signals on the display 28 and speakers 22. When basic cable only is desired, the cable from the wall typically carries TV signals in QAM or NTSC format and is plugged directly into the “F-type connector” on the TV chassis in the U.S., although the connector used for this purpose in other countries may vary. In contrast, when the user has an extended cable subscription for instance, the signals from the head end are typically sent through a STB which may be separate from or integrated within the TV chassis but in any case which sends HDMI baseband signals to the TV when the source is external to the TV. Other types of connections may be used, e.g., MOCA, USB, 1394 protocols, DLNA.

Similarly, HDMI baseband signals transmitted from a satellite source of TV broadcast signals received by an integrated receiver/decoder (IRD) associated with a home satellite dish may be input to the AVDD 12 for presentation on the display 28 and speakers 22. Also, streaming video may be received from the Internet for presentation on the display 28 and speakers 22. The streaming video may be received at the network interface 24 or it may be received at an in-home modem that is external to the AVDD 12 and conveyed to the AVDD 12 over a wired or wireless Ethernet link and received at an RJ45 or 802.11x antenna on the TV chassis.

Also, in some embodiments one or more cameras 50, which may be video cameras integrated in the chassis if desired or mounted separately and electrically connected thereto, may be connected to the processor 18 to provide to the processor 18 video images of viewers looking at the display 28. The one or more cameras 50 may be positioned on top of the chassis of the AVDD, behind the display and looking through display, or embedded in the display. Because the cameras 50 are intended to detect a person's appendage such as a hand or finger, they may be infrared (IR) cameras embedded behind the display.

Use of two or more cameras 50 can make locating the position of a hand or finger in 3D space by the processor 18 easier. The cameras 50 may be two similar cameras, i.e. one conventional and one IR camera. Since the camera locations are known by the processor 18, by training the size of the hand or input object can be learned, hence distance can be easily determined. Yet again, if three cameras are used, no training would be required as XYZ can be resolved by triangulation. An alternative option to the use of cameras 50 is proximity technology to enable repositioning of the virtual control ICONs. The following patent documents, incorporated herein by reference, disclose such technology: USPPs 2008/0122798; 2010/0127970; 2010/0127989; 2010/0090948; 2010/0090982.

The processor 16 may also communicate with an infrared (IR) or radiofrequency (RF) transceiver 52 for signaling to a source 54 of HDMI. The processor 16 may receive HDMI audio video signals and consumer electronics control (CEC) signals from the source 54 through an HDMI port 56. Thus, the source 54 may include a source processor 58 accessing a computer readable storage medium 60 and communicating signals with an HDMI port 62, and/or IR or IP transceiver 64.

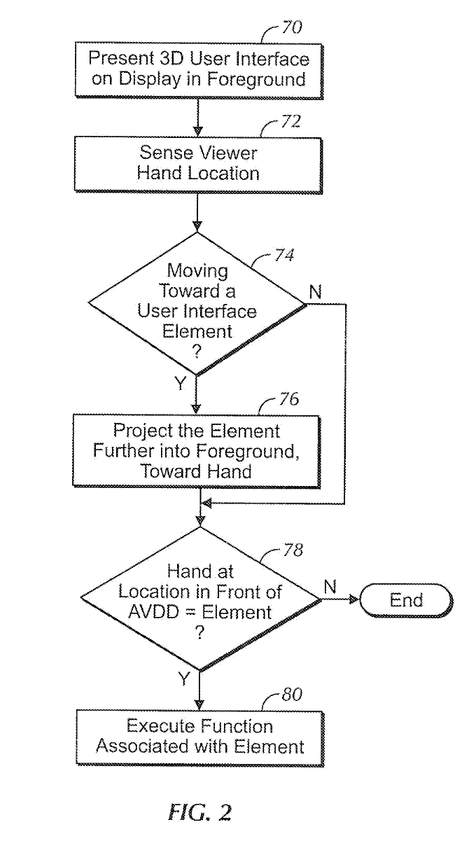

Moving in reference to FIG. 2, a flow chart begins at block 70, where a 3D UI can be presented on the display 28 of an AVDD 12 and in the foreground at a point that is distanced from the display 28 that is perpendicular to the display 28. At least one camera 50 may image the viewer's appendage and communicate the image to the processor 18. The processor 18 can determine, or “sense” the location of the viewer's hand at block 72. A sequence of images taken by the camera 50 and sent to the processor 18 can be used to determine whether the viewer's hand is moving toward a UI element at decision diamond 74. If the hand is determined to be moving closer to a UI element, the processor 18 may animate the element to move translationally further into the foreground toward the viewer's hand at block 76. A determination by the processor 18 that the hand is not moving toward a UI element at decision diamond 74, on the other hand, causes the logic to move to decision diamond 78, at which step the processor 18 can determine, using images taken by the camera(s) 50, whether the hand is located in front of the AVDD 12 or an element projected into the foreground. A determination that the hand is not located in front of the AVDD 12 or a UI element terminates the flow of logic. However, if the hand is in fact at a location in front of a UI element, the processor 18 executes the function associated with the UI element at block 80.

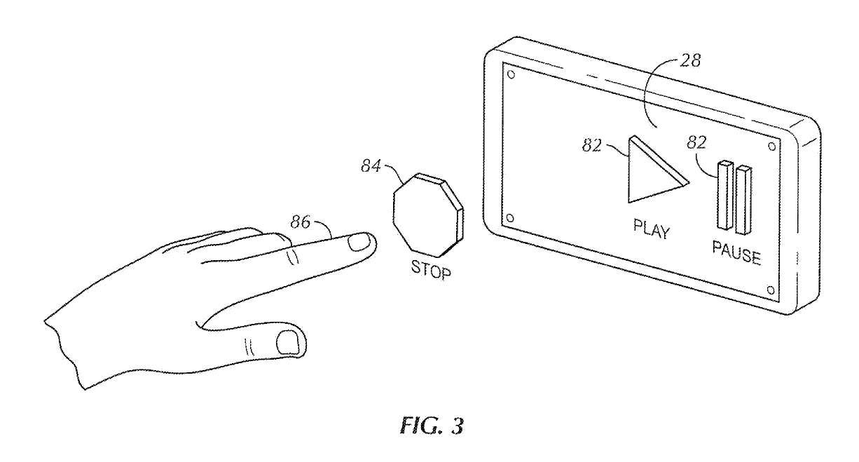

Now referring to FIG. 3, a schematic diagram of a 3D UI includes an AVDD device 12 with 3D display 28, here an autostereoscopic display. One or more 2D UI elements 82 can be presented on the display 28 by the processor 18.

Additionally, one or more 3D UI elements 84 can be presented at a location in front of the display 28 at a distance closer to the viewer than the display plane, i.e., at a location that is closer to the viewer than the display plane along an axis (conventionally, the z-axis) which is perpendicular to the display 28. This is to say that the UI elements 84 appear closer to the viewer than the display plane in the dimension that is perpendicular to the display, but note that the UI element 84 itself also may be offset from the display left or right or up or down (i.e., in the x- and y-dimensions) as well as in the z-dimension.

The image that comprises the entire display 28, regions of the entire display 28, or just the UI elements 82, 84 can be presented in 3D. Presentation of 3D UI elements 84 by the processor 18 can allow more distance between elements 84 and hence make it easier for the user to view and select the appropriate element 84. Location of a viewer's hand 86 can be determined by the processor 18 through images taken by the camera(s) 50.

While the particular 3D USER INTERFACE FOR AUDIO VIDEO DISPLAY DEVICE SUCH AS TV is herein shown and described in detail, it is to be understood that the subject matter which is encompassed by the present invention is limited only by the claims.

What is claimed is:

1. Audio video display device (AVDD) comprising:
processor;
video display; and
computer readable storage medium bearing instructions executable by the processor to:
present a three dimensional (3D) user interface (UI) on the video display in a foreground of an image of the display such that at least a first element of the 3D UI has a simulated element position that makes the first element appear to be closer to a viewer of the display than the image in a dimension that is perpendicular to the image presented on the display;
detect a person's appendage in proximity to the first element; and
responsive to a determination that the person's appendage is substantially co-located with the simulated element position, execute a first function associated with the first element.

2. The AVDD of claim 1, wherein the simulated element position is distanced from the display in the dimension that is perpendicular to the image presented on the display.

3. The AVDD of claim 1, wherein the 3D UI includes plural elements at least some of which appear to be closer to a viewer of the display than the image in a dimension that is perpendicular to the image presented on the display.

4. The AVDD of claim 1, wherein the 3D UI includes plural elements all of which appear to be closer to a viewer of the display than the image in a dimension that is perpendicular to the image presented on the display.

5. The AVDD of claim 1, comprising at least one camera imaging the person's appendage and communicating with the processor, the processor determining a location of the appendage relative to the display using the image.

6. The AVDD of claim 5, comprising at least two cameras imaging the person's appendage and communicating with the processor, the processor determining a location of the appendage relative to the display using images from both cameras.

7. The AVDD of claim 5, comprising three cameras imaging the person's appendage and communicating with the processor, the processor determining a location of the appendage relative to the display using images from all three cameras.

8. The AVDD of claim 1, wherein the processor, responsive to a determination that the person's appendage is moving toward the simulated element position, animates the first element to make the first element to move toward the person's appendage in the dimension that is perpendicular to the image presented on the display.

9. Audio video display device (AVDD) comprising:
processor;
video display; and
computer readable storage medium bearing instructions executable by the processor to present on the display a 3D UI at least a portion of which appears to be in front of the display and distanced therefrom.

10. The AVDD of claim 9, wherein a first element of the 3D UI has a simulated element position that makes the first element appear to be closer to a viewer of the display than the image in a dimension that is perpendicular to the image presented on the display, and the processor:
detects a person's appendage in proximity to the first element; and
responsive to a determination that the person's appendage is substantially co-located with the simulated element position, executes a first function associated with the first element.

11. The AVDD of claim 10, wherein the simulated element position is distanced from the display in the dimension that is perpendicular to the image presented on the display.

12. The AVDD of claim 9, wherein the 3D UI includes plural elements at least some of which appear to be closer to a viewer of the display than an image in a dimension that is perpendicular to the image presented on the display.

13. The AVDD of claim 9, wherein the 3D UI includes plural elements all of which appear to be closer to a viewer of the display than an image in a dimension that is perpendicular to the image presented on the display.

14. The AVDD of claim 9, comprising at least one camera imaging a person's appendage and communicating with the processor, the processor determining a location of the appendage relative to the display using the image.

15. The AVDD of claim 14, comprising at least two cameras imaging the person's appendage and communicating with the processor, the processor determining a location of the appendage relative to the display using images from both cameras.

16. The AVDD of claim 14, comprising three cameras imaging the person's appendage and communicating with the processor, the processor determining a location of the appendage relative to the display using images from all three cameras.

17. The AVDD of claim 10, wherein the processor, responsive to a determination that the person's appendage is moving toward the simulated element position, animates the first element to make the first element to move toward the person's appendage in the dimension that is perpendicular to the image presented on the display.

18. Method, comprising:
presenting an image on a 3D video display; and
presenting in simulated space in front of the image and distanced therefrom a user interface (UI) including at least one element selectable by a person by the person locating an appendage at a location in front of the 3D video display and distanced therefrom.

19. The method of claim 18, comprising executing a function associated with the element when the person's appendage is located at a location in front of the 3D video display and distanced therefrom which corresponds to a simulated location of the element.

20. The method of claim 18, comprising using a camera to determine a location of the appendage.
